(19) United States
(12) Patent Application Publication
(10) Pub. No.: US 2017/0146037 A1
(43) Pub. Date: May 25, 2017

(54) Pneumatic Actuator

(71) Applicant: Jamar International, Inc., DBA UniTorq Actuators and Controls, Duluth, GA (US)

(72) Inventor: Jack Curtin, Duluth, GA (US)

(21) Appl. No.: 15/359,592

(22) Filed: Nov. 22, 2016

Related U.S. Application Data
(60) Provisional application No. 62/259,762, filed on Nov. 25, 2015.

(51) Int. Cl. F15B 15/06; F16H 19/04; F15B 15/14

(52) U.S. Cl. CPC F15B 15/065; F15B 15/1447; F16H 19/04; F16K 31/122

(57) ABSTRACT

This disclosure provides a valve actuator that has improved durability and efficiency. The valve actuator includes a housing cylinder having a pinion centrally located, running perpendicular to the cylinder, secured at the top with a circlip, sealed with o-rings and friction reducing bearings both at the top and bottom. A pair of pistons with linear gear teeth mates to opposite sides of the pinion and seals against the cylinder's interior with o-rings and friction reducing bearings. A cam, connected to the central pinion is stopped by bolts run into the cylinder at the end of both closing and opening strokes. The body is sealed with two endcaps having internal o-rings and secured with cap screws.

### PRIORITY CLAIM

This application claims priority to U.S. Provisional Application No. 62/259,762, filed Nov. 25, 2015. The entire contents of that application are incorporated herein by reference.

### FIELD

This disclosure relates to actuators. More particularly, this disclosure relates to a pneumatic rack and pinion actuator for industrial automation of a quarter turn valve.

### BACKGROUND

Pneumatic rack and pinion actuators are operated using compressed air (typically having between 20 and 120 PSIG) for the purpose of opening and closing a valve remotely. The actuator is mounted on a valve stem and, when mounted with a solenoid valve, has the ability to be selectively charged and discharged with pressurized air to create the necessary torque to open and close the valve. The torque is created when two pistons with “racks” (linear gear teeth) are pushed either in opposing directions or toward each other by pressurized air or spring force, and as a result, turn the central pinion in a clockwise or counterclockwise direction. A cam attached to the pinion is stopped by bolts that are threaded into the body. The bolts are adjustable for the purpose of defining a custom travel within a specified amount of degrees fully open and fully closed.

Because the pinion bears the stopping force at both the open and closing strokes of the operation, one of the most common failures in a pneumatic actuator is the o-ring that seals between the top of the pinion and the actuator body. Further, another point of high stress (and, thus, failure) of pneumatic rack and pinion actuators is the pinion teeth. Therefore, a need exists for an improved actuator that can better endure the stresses and forces of normal operation.

### SUMMARY

This disclosure provides a pneumatic actuator comprising a body having a length and width. The body comprises a first generally cylindrical opening through its length. The first generally cylindrical opening comprises a first end and second end. The body also comprises a second generally cylindrical opening perpendicular to the first generally cylindrical opening, so that the second opening extends perpendicularly from the first generally cylindrical opening through the top and bottom of the actuator. Furthermore, the diameter of the second generally cylindrical opening is smaller than the diameter of the first generally cylindrical opening.

The actuator also comprises a first piston having at least a portion disposed inside the first end of the first generally cylindrical opening of the body. The first piston comprises a first rack. The actuator also comprises a second piston having at least a portion disposed inside the second end of the first generally cylindrical opening of the body. The second piston comprises a second rack.

The actuator also comprises a pinion. The pinion is oriented inside the second generally cylindrical opening so that a first portion of the pinion protrudes from the body through the second generally cylindrical opening, a second portion of the pinion is disposed inside the second generally cylindrical opening, and a third portion of the pinion is disposed inside the first generally cylindrical opening. Further, the pinion comprises a plurality of teeth. Two or more of the teeth of the pinion engage the first rack of the first piston and two or more teeth of the pinion engage the second rack of the second piston.

The actuator also comprises an o-ring disposed around a portion of the second portion of the pinion that is disposed inside the second generally cylindrical opening of the body. Further, the actuator comprises a first bearing around a portion of the first portion of the pinion that protrudes from the body. This first bearing is proximate to the o-ring that is around the pinion. The actuator also comprises a second bearing around a portion of the second portion of the pinion that is disposed inside the second generally cylindrical opening of the body. This second bearing is also proximate to the o-ring, but on the other side of the o-ring from the first bearing.

In some embodiments, the body of the actuator comprises extruded aluminum. In some embodiments, the pinion comprises alloy steel, stainless steel, or anodized aluminum alloy. In further embodiments, the pinion further comprises a cam attached to a top end of the first portion of the pinion that protrudes from the body through the second generally cylindrical opening. In certain embodiments, the cam comprises forged carbon steel. In some embodiments, the cam is attached to the top end of the first portion of the pinion that protrudes from the body through the second generally cylindrical opening via a hex drive.

In some embodiments, the first piston and/or the second piston comprise cast steel or aluminum. In further embodiments, the first piston and/or the second piston comprise a reinforcing rib.

In further embodiments, the body further comprises one or more skate bearings configured to facilitate movement of the first piston within the first generally cylindrical opening. In some embodiments, the body further comprises one or more skate bearings configured to facilitate movement of the second piston within the first generally cylindrical opening. In some embodiments, the first piston and/or the second piston further comprise an o-ring.

In some embodiments, the pneumatic actuator further comprises a first spring cartridge operably engaged with the first piston. In some embodiments, the pneumatic actuator further comprises a second spring cartridge operably engaged with the second piston.

In some embodiments, the pneumatic actuator further comprises a pinion circlip disposed around the pinion.

### BRIEF DESCRIPTION OF THE FIGURES

FIG. 1 is an exploded view showing exemplary parts and orientations used in the assembly of an embodiment of the pneumatic rack and pinion actuator disclosed herein.

FIG. 2 is a representation of the upper pinion bearing system.

FIG. 3 is a cut away of an embodiment of the actuator assembled in a “fail closed” configuration, showing the pinion and pistons in the closed position.

FIG. 4 is a cut away of an embodiment of the actuator assembled in a “fail open” configuration, showing the pinion and pistons are in the closed position.

FIG. 5 shows an embodiment of actuator with the body cut to show the “A” port interior.

FIG. 6 shows an embodiment of an assembled actuator with the body cut to show the “B” port interior and the air channel running along the body length.

### DETAILED DESCRIPTION

This disclosure provides a pneumatic actuator that reduces stress on the pinion and pinion o-ring, thereby improving durability and efficiency of the actuator. The pneumatic actuator of this disclosure comprises two bearings, a first bearing around a portion of the top of the pinion that extends outside of the body, and a second bearing around a portion of the pinion that is disposed inside the body of the actuator. The first bearing extends downwards to the upper pinion o-ring and the second bearing extends upward toward the upper pinion o-ring. This configuration reduces the stress exerted on the upper pinion o-ring during the end of the opening and closing stroke, resulting in an actuator that lasts longer (e.g., has a longer cycle life) and is less likely to fail.

Another aspect of this disclosure provides a pneumatic actuator having two or more pinion teeth in contact with each rack at all times during operation. This configuration distributes the stress of actuation more evenly and reduces wear, resulting in an actuator that is more durable and less likely to fail.

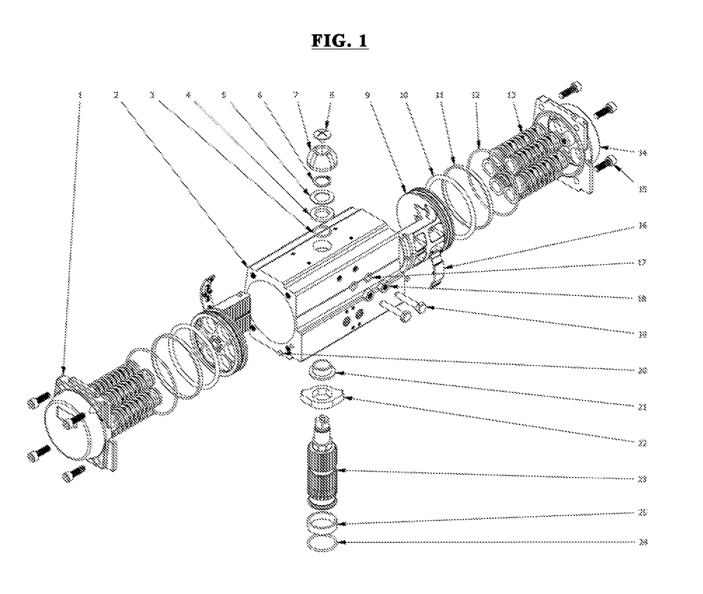

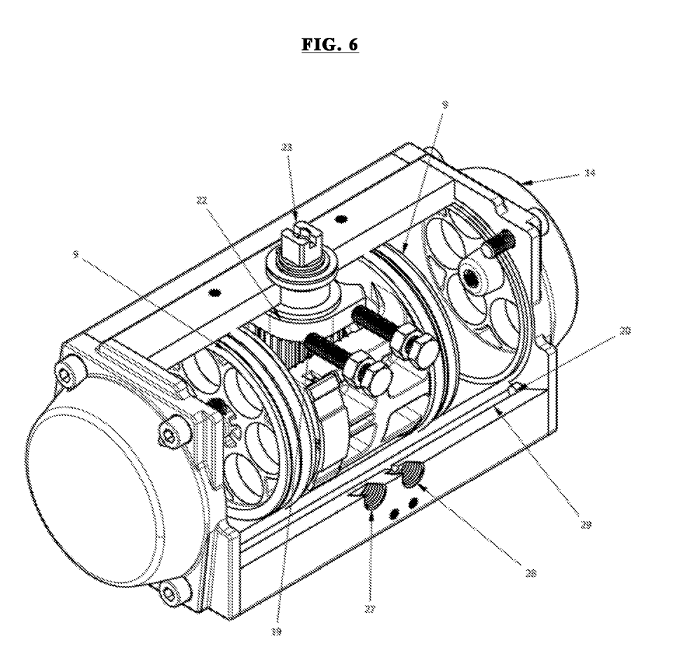

FIG. 1 is an exemplary embodiment depicting an exemplary actuator assembly and their orientations when assembled. The actuator assembly consists of a body (2). The actuator body (2) can be made of extruded aluminum. The actuator body (2) has a generally cylindrical bore through its length. In some embodiments, actuator body (2) has a second hole drilled down its length which allows air to enter the cavity behind the pistons (9) via two holes drilled at either end of the body that interfere with this channel. This second hold is also shown as air channel (29) in FIG. 6. The ends of this hole are sealed with air channel plugs (20) to prevent leaking and direct air properly.

Pinion (23) is disposed in a second generally cylindrical bore that is perpendicular to the axis of the bore that goes through the length of body (2). In some embodiments, pinion (23) is machined from either alloy steel and plated using electroless nickel plating, made from stainless steel, or anodized aluminum alloy. It is sealed both at the top of the body (2) and at the bottom with o-rings. The pinion is equipped with a bearing (25) at the base to prevent metal on metal wear, and sealed with an o-ring (24). The top of the pinion is constructed with both internal (21) and external (4) bearings in order to shield the o-ring (3), and protect it from excessive wear along the axis of the pinion (23). The pinion (23) is held in place by the pinion circlip (6) and supported from downward thrust by the pinion washer (5). Cam (22) is fixed to the pinion top. In some embodiments, the cam comprises forged carbon steel and electroless nickel plated. In some embodiments, the cam is fixed to the pinion top using a hex drive. In some embodiments, the pinion top is fitted with one of various types of visual indicators to provide a visual indication of the position of the actuator and, thus, the flow through the valve. Multiple types of visual indication can be fitted to the top of the pinion. The indicator shown in FIG. 1 is a dome (7). Dome (7) is attached to the pinion via screw (8). In some embodiments, the screw comprises colored plastic inserts configured 180 degrees from each other thereby creating a line through the dome. Traditionally, when the line runs parallel with the actuator's main bore, the indicator indicates that the actuator, (and, therefore, an attached valve) is in the open position.

In some embodiments, pistons (9) used in the actuator assembly are cast steel or aluminum, machined, and anodized. Piston (9) comprises a series of linear gear teeth that mate to the pinion (23) (also referred to as a “rack”). In some embodiments, the teeth are separated by a reinforcing rib. The reinforcement not only strengthens the casting but also guards against pinion (23) blow out in the case of a circlip failure. At the point where the end of the racks touch the body, skate bearings (16) are used to lubricate the piston's (9) movement and prevent galling of the bore. The outer diameters of each the pistons (9) seal against the bore with an o-ring (10) and are lubricated with a bronze impregnated PTFE strip (11). The backs of the pistons (9) and the front of the cast steel end caps (14,1) have indentions fitting spring carriages (13). In some embodiments, the spring cartridges (13) are epoxy coated spring steel compressed or flared onto a brass rod retained by two ABS end pieces. The right end cap (14) and the left end cap (1) are secured with four stainless steel socket head cap screws (15; not shown for end cap (1)) each, and seal against the body (2) with o-rings (12). Two stop bolts, each consisting of an oval point bolt (19) sealed into place with a stainless steel nut (18) that is manufactured with an o-ring groove and fitted with an o-ring (17), are threaded into the body (2) until they make contact with the pinion cam (22) at the desired open and closed positions.

In some embodiments, for all points of contact in the actuator, grease is applied at assembly for sealing and lubrication. This includes all bearings and seals, the bore of the actuator, the teeth of the piston (9) and the pinion (23) teeth. In some embodiments, for applications where the operating temperature is −58° F. to 176° F., pinion bearings (25,21,4) and skate bearings (16) are made using Delrin, o-rings are NBR, and Berulub FR-16 grease is used for lubrication. In other embodiments, for applications where the operating temperature is 176° F. to 320° F., pinion bearings (25,21,4) and skate bearings (16) are made using PPSU (polyphenylsulfone), o-rings are Viton, and Royal Purple Ultra-Performance Grease is used for lubrication.

The body (2) of the actuator may be anodized type II, anodized type II and painted, anodized type II and PTFE coated, anodized type III, anodized type III and PTFE coated, or electroless nickel plated. The pinion (23) drive may be either a double square, double D, or bore and key. The total stroke of the actuator may vary by a total of about 10 degrees at both ends of the stroke as controlled by the cam (22) and stop bolts (19). The nominal travel of the actuator assembly may be 90°, 120°, 135°, 180°, or anywhere between about 90° and about 180°. This is accomplished by changing of the pistons (9), the cam (22) and the body (2) to allow for longer stroke.

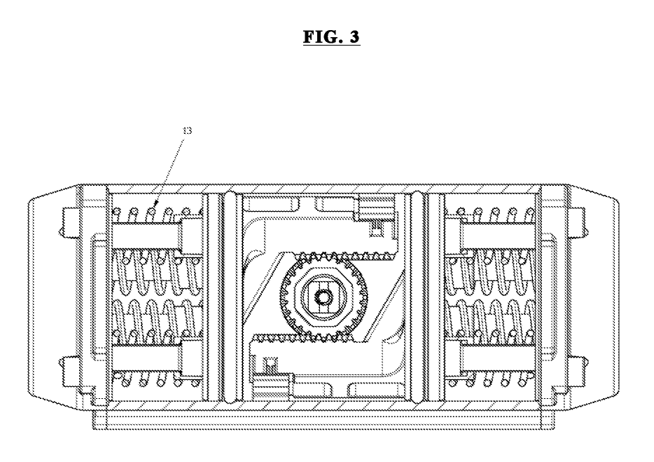

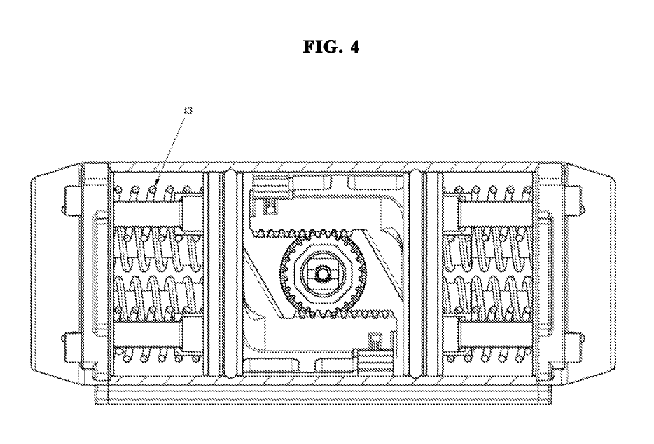

The actuator assembly can be assembled with or without the inclusion of the spring cartridges (13). When assembled without spring cartridges (13), it is referred to as “double acting” and requires pressurized air to both open and close. If a double acting actuator were to lose air pressure there is no designated “fail position” of the actuator and thus the valve it is installed on. When assembled with spring cartridges (13), the actuator only needs pressurized air to open and the springs (13) will close the actuator. A spring return actuator can be assembled either “fail open” or “fail closed” named for the intended effect it is to have on the valve. FIG. 3 shows an actuator assembled in a “fail closed” configuration. The actuator opens the valve counter clockwise and closes the valve clockwise using springs (13) once any pressurized air is vented. In a “fail open” actuator assembly, such as the one shown in FIG. 4, the pinion and cam assembly is turned to the “valve open” position when the actuator is closed and the direction of the pistons are reversed. In this configuration the actuator will still open the valve counter clockwise and close it clockwise, however when air is vented it will turn counter clockwise to the “valve open position”.

In some embodiments, threaded holes in the top of the body (2) conform to VDI/VDE 3845 (Verein Deutscher Ingenieure/Verband Deutscher Elektrotechniker, a German-based, European standards organization; VDI/VDE 3845 relates to interfaces of valves and auxiliary equipment) for the mounting of brackets and indication. Threaded holes on the face of the body are made up of two threaded holes for air fittings and four threaded holes for the mounting of solenoids. In some embodiments, these holes also conform to VDI/VDE 3845 and/or have NPT threads. The bottom of the actuator may have anywhere from one to two mounting patterns. In some embodiments, the bottom of the actuator has more than two mounting patterns. In some embodiments, the bolt circles and depth of these patterns conform to ISO5211. However the threads of these holes may be UNC/UNF threads or metric threads.

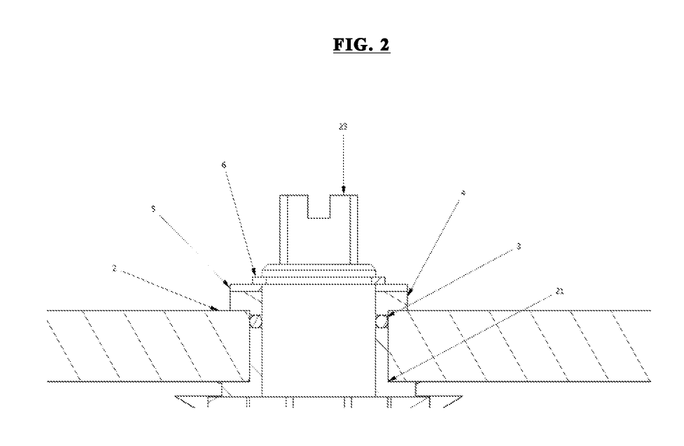

FIG. 2 details of an embodiment of the top pinion bearing system. The pinion (23) is held in place by the pinion circlip (6) and supported from downward thrust by the pinion washer (5). The pinion o-ring (3) does not have a groove in the pinion (23) but instead seals against the pinion (23) and the actuator body (2) and is kept in place by the flange bearing (4), which extends along the top of the body (2) and down along the pinion (23) to the o-ring (3), and the thrust bearing (21) which extends along the second generally cylindrical counter bore inside the body (2) and up towards the o-ring (3).

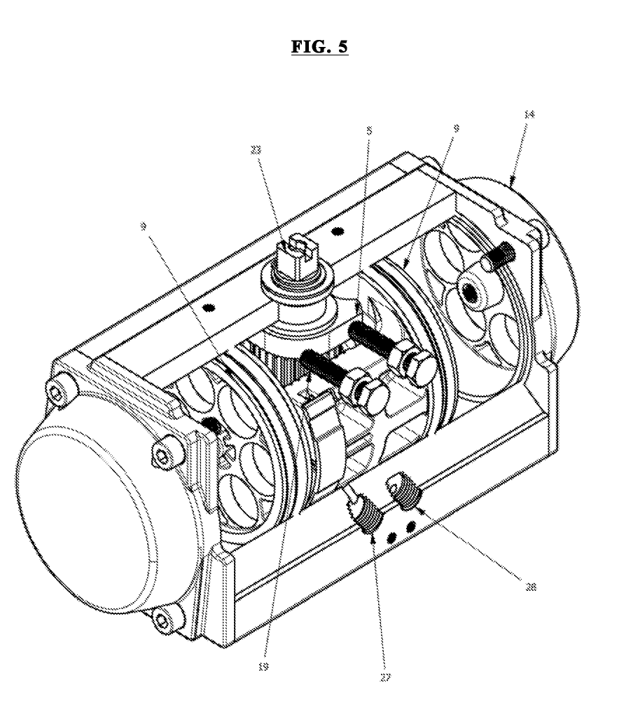

FIG. 5 and FIG. 6 show how air is used to generate torque. When port “A” (27) is pressurized it allows the air to flow between the two pistons (9) and pushes them apart. Air is allowed to vent out the air channel (29) through a vent hole that connects the main bore of the actuator to the air channel. The pistons (9), in turn, rotate the pinion (23) and generate torque. The pistons (9) are stopped when then the pinion cam (5) hits the stop bolt (4) (shown in FIG. 1). When Port “B” (28) is pressurized, the air channel (29) allows air behind the pistons (9), and as air escapes out of port “A” (27), the pistons (9) move closer together generating torque in the opposite direction. This stroke is again stopped when the pinion cam (22) makes contact with the stop bolt (19).

1. A pneumatic actuator comprising:
a body having a length and width, the body comprising:
a first generally cylindrical opening through its length, wherein the first generally cylindrical opening comprises a first end and a second end; and
a second generally cylindrical opening perpendicular to the first generally cylindrical opening that extends from the first generally cylindrical opening through the top and bottom of the actuator, wherein the diameter of the second generally cylindrical opening is smaller than the diameter of the first generally cylindrical opening;
a first piston having at least a portion disposed inside the first end of the first generally cylindrical opening of the body, wherein the first piston comprises a first rack;
a second piston having at least a portion disposed inside the second end of the first generally cylindrical opening of the body, wherein the second piston comprises a second rack;
a pinion comprising teeth, wherein
a first portion of the pinion protrudes from the body through the second generally cylindrical opening,
a second portion of the pinion is disposed inside the second generally cylindrical opening,
a third portion of the pinion is disposed inside the first generally cylindrical opening, and
two or more of the teeth of the pinion engage the first rack and two or more teeth of the pinion engage the second rack;
an o-ring disposed around a portion of the second portion of the pinion that is disposed inside the second generally cylindrical opening of the body;
a first bearing around a portion of the first portion of the pinion that protrudes from the body, wherein the first bearing is proximate to the o-ring; and
a second bearing around a portion of the second portion of the pinion that is disposed inside the second generally cylindrical opening of the body, wherein the second bearing is proximate to the o-ring.

2. The pneumatic actuator of claim 1, wherein the body comprises extruded aluminum.

3. The pneumatic actuator of claim 1, wherein the pinion comprises alloy steel, stainless steel, or anodized aluminum alloy.

4. The pneumatic actuator of claim 1, wherein the pinion further comprises a cam attached to a top end of the first portion of the pinion that protrudes from the body through the second generally cylindrical opening.

5. The pneumatic actuator of claim 4, wherein the cam comprises forged carbon steel.

6. The pneumatic actuator of claim 4, wherein the cam is attached to the top end of the first portion of the pinion that protrudes from the body through the second generally cylindrical opening via a hex drive.

7. The pneumatic actuator of claim 4, wherein the cam further comprises a visual indicator.

8. The pneumatic actuator of claim 1, wherein the first piston and second piston each comprise cast steel or aluminum.

9. The pneumatic actuator of claim 1, wherein the first piston and the second piston each comprise a reinforcing rib.

10. The pneumatic actuator of claim 1, wherein the body further comprises one or more skate bearings configured to facilitate movement of the first piston within the first generally cylindrical opening.

11. The pneumatic actuator of claim 10, wherein the body further comprises one or more skate bearings configured to facilitate movement of the second piston within the first generally cylindrical opening.

12. The pneumatic actuator of claim 1, wherein the first piston and the second piston each further comprise an o-ring.

13. The pneumatic actuator of claim 1, further comprising a first spring cartridge operably engaged with the first piston and a second spring cartridge operably engaged with the second piston.

14. The pneumatic actuator of claim 1, further comprising a pinion circlip disposed around the pinion.
